(19) United States
(12) Patent Application Publication
(10) Pub. No.: US 2009/0055835 A1
(43) Pub. Date: Feb. 26, 2009

(54) System and Method for Managing License Capacity in a Telecommunication Network

(75) Inventor: Zhongwen Zhu, Saint-Laurent (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/841,459

(22) Filed: Aug. 20, 2007

(51) Int. Cl. G06F 9/50

(52) U.S. Cl. 718/105

(57) ABSTRACT

According to teachings herein, a telecommunication network manages licensed transaction capacity for a licensed service provided by the network, based on dynamically adjusting the allocation of licensed capacity across multiple traffic processors providing the service. Reallocation of licensed capacity is performed with respect to the actual traffic loads at the traffic processors. For example, licensed capacity at a lightly loaded traffic processor is decreased and licensed capacity is correspondingly increased at a heavily loaded traffic processor. This dynamic redistribution of licensed capacity to reflect variations in the distribution of traffic loads across the traffic processors provides for more efficient utilization of the licensed transaction capacity.

### BACKGROUND

1. Technical Field

The present invention generally relates to telecommunication networks, such as wireless communication networks, and particularly relates to managing license capacity within such networks.

2. Background

Telecommunication networks offer an increasing range of services. For example, wireless communication networks, e.g., cellular networks, now offer their subscribers a wide range of packet data services, such as instant messaging, multimedia messaging, etc. Increasingly, the software enabling these services and other features rely on capacity licensing.

With capacity licensing, the amount or rate of service traffic is limited. For example, a network operator may deploy an instant messaging (IM) service, subject to a licensed upper limit on the number of instant messages that can be processed within the operator's network, or at specific nodes within the operator's network. The limit may be specified as, for example, X messages-per-second (MPS), where X represents some number.

In general, a given service is subject to a transactions-per-second (TPS) limit or other capacity license constraint. The traffic processors within the network that process traffic for the licensed service share the overall licensed capacity. It is known to make a static distribution of licensed capacity across the involved traffic processors. However, such distributions do not provide for efficient utilization of licensed capacity.

In more detail, in a single network node, for example, multiple licensed services can be deployed and run across a set of traffic processors. Thus, each such traffic processor processes traffic for one or more licensed services. As an example, licensed chat and IM services both may be deployed across the set of traffic processors.

With multiple licensed services being supported by the node, disparities may arise in the amount of licensed traffic being handled by the node for the different types of licensed service. For example, a first one of the traffic processors in the node may have an eighty percent load for IM traffic and a twenty percent load for chat traffic, while another traffic processor in the node may have a fifty percent load for both the IM and chat services traffic. Splitting the licensed transaction capacities for the different services across the traffic processors in a equal and/or static approach thus may yield good license utilization at some traffic processors, at least for some services, but may result in poor license utilization at other traffic processors.

### SUMMARY

According to teachings herein, a telecommunication network manages licensed transaction capacity for one or more licensed services provided by the network, based on dynamically reallocating licensed capacity across multiple traffic processors providing the service. Reallocation is performed with respect to the actual traffic loads at the traffic processors, for at least one of the licensed services being managed.

As a non-limiting example, a method of managing license capacity for a service in a telecommunication network comprises initially allocating portions of a licensed transaction capacity to individual traffic processors supporting the service, and dynamically adjusting the allocated portions based on actual traffic loads of the individual traffic processors.

Traffic loads may be evaluated by comparing the traffic load at the individual traffic processors, which may be expressed in terms of license usage levels, e.g., a measure of the extent to which the amount of licensed capacity currently allocated to a given traffic processor is being utilized. In one or more embodiments, comparing the traffic loads to lower and upper load thresholds provides a basis for determining whether each traffic processor is lightly loaded or heavily loaded with respect to is current allocation of licensed capacity. Dynamic reallocation, for example, decreases the allocated capacity at one or more lightly loaded traffic processors and reallocates some or all of that released capacity to one or more heavily loaded traffic processors, thereby making better use of the overall licensed transaction capacity.

In another embodiment, a license manager manages licensed transaction capacity for one or more licensed services in a telecommunication network. The license manager comprises one or more processing circuits configured to initially allocate portions of a licensed transaction capacity to individual traffic processors supporting the service, and dynamically adjust the allocated portions based on actual traffic loads of the individual traffic processors. The processing circuits may comprise hardware, software or any combination thereof. In at least one embodiment, the processing circuits of the license manager comprise one or more special- or general-purpose microprocessors executing stored program instructions providing the license management functionality.

In one or more embodiments, the license manager is located in or functionally associated with a single node in the telecommunication network, where the single node includes a set of traffic processors for processing traffic for one or more licensed services. In such embodiments, the license manager comprises a local license manager that provides dynamic reallocation of an overall licensed transaction capacity across the set of traffic processors within the node. The license manager also may comprise a license server, and the local license manager may be configured to communicate with the license server. For example, in at least one embodiment, the local license manager requests additional license capacity from the license server, such as in response to detecting high levels of license usage at one or more of the traffic processors in the set of traffic processors being managed by the local license manager.

In another embodiment, the individual traffic processors subject to license management comprise a set of traffic processors spanning two or more nodes within a telecommunication network. In at least one such embodiment, the license manager comprises a license server configured to dynamically adjust the allocated portions of licensed capacity across the two or more nodes. The license manager may further comprise, or at least be associated with, a local license manager in each of the two or more nodes. Each local license manager may be communicatively coupled to the license server and configured to report actual traffic load information to the license server, to support the dynamic reallocation of the allocated portions across the two or more nodes by the license server.

In yet another embodiment, a license manager manages licensed transaction capacity for one or more services in a telecommunication network and includes one or more processing circuits configured to distribute an overall number of license tokens among individual traffic processors in a set of traffic processors, where the overall number of license tokens represent a licensed transaction capacity for a licensed service. The license manager is further configured to redistribute the license tokens among the individual traffic processors responsive to differences in license token usage levels among the individual traffic processors. As an example, the license manager may make an initial, uniform distribution of license tokens (i.e., a uniform distribution of licensed capacity), and then dynamically redistribute the license to reflect differences in license token usage among the traffic processors.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a telecommunication network that includes a license manager for managing license capacity for one or more licensed services provided by the telecommunication network.

FIG. 2 is a block diagram for one embodiment of a license manager configured to manage license capacity for a set of traffic processors providing processing for traffic associated with a licensed service.

FIG. 3 is a logic flow diagram for one embodiment of license capacity management processing.

FIGS. 4 and 5 are diagrams of licensed capacity utilization before and after dynamic adjustment of licensed capacity at a traffic processor, in accordance with the processing of FIG. 3, for example.

FIG. 6 is a block diagram of one embodiment of a node in a telecommunication network, wherein a local license manager and/or a license server provide license capacity management for a set of traffic processors within the node.

FIG. 7 is a block diagram of one embodiment of plural nodes in a telecommunication network, wherein local license managers and/or a license server provide license capacity management for a set of traffic processors spanning two or more nodes.

FIGS. 8 and 9 are logic flow diagrams illustrating example details for license capacity management processing, such as introduced in FIG. 3.

FIG. 10 is a logic flow diagram for another embodiment of capacity license management processing.

### DETAILED DESCRIPTION

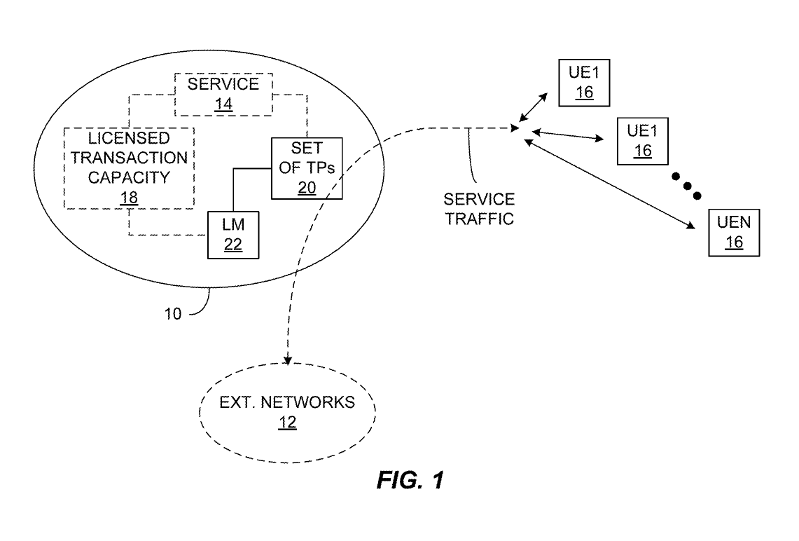

As a non-limiting example, FIG. 1 illustrates an embodiment of a telecommunication network 10, which may connect to one or more external networks 12 (e.g., the Internet), and which provides a licensed service 14 to one or more subscribers, represented as user equipment 16 (denoted in the drawing as multiple subscriber devices UE1, UE2, . . . , UEN). The service 14, such as an instant-messaging (IM) service, is subject to a capacity license. With capacity licensing, the overall amount or rate of traffic for the service is capped or otherwise constrained by a licensed transaction capacity 18. For the non-limiting IM service example, the licensed transaction capacity 18 may be expressed as a maximum allowed messages-per-second (MPS) value. More broadly, the licensed transaction capacity 18 may be expressed as a limit on the allowed number of transactions-per-second (TPS), or expressed as some other constraint that limits the volume or rate of traffic permitted to be processed for the licensed service 14.

To that end, and of particular interest herein, the set 20 of individual traffic processors that process the service traffic operate under the control of a license manager 22. According to teachings herein, the license manager 22 makes an initial distribution of the licensed transaction capacity 18 among the individual traffic processors (not individually shown) within the traffic processor set 20. The allocation of licensed capacity to each traffic processor caps or otherwise sets that traffic processor's capacity for processing traffic for the licensed service 14. The license manager 22 thereafter ensures efficient utilization of the licensed transaction capacity 18 by dynamically redistributing the licensed transaction capacity 18 among the individual traffic processors, as a function of the actual traffic loads at the individual traffic processors. Those skilled in the art will appreciate that the license manager may be configured to provide license management for any number of licensed services, where the management of license capacity for each such service is based on the actual traffic loads for that service.

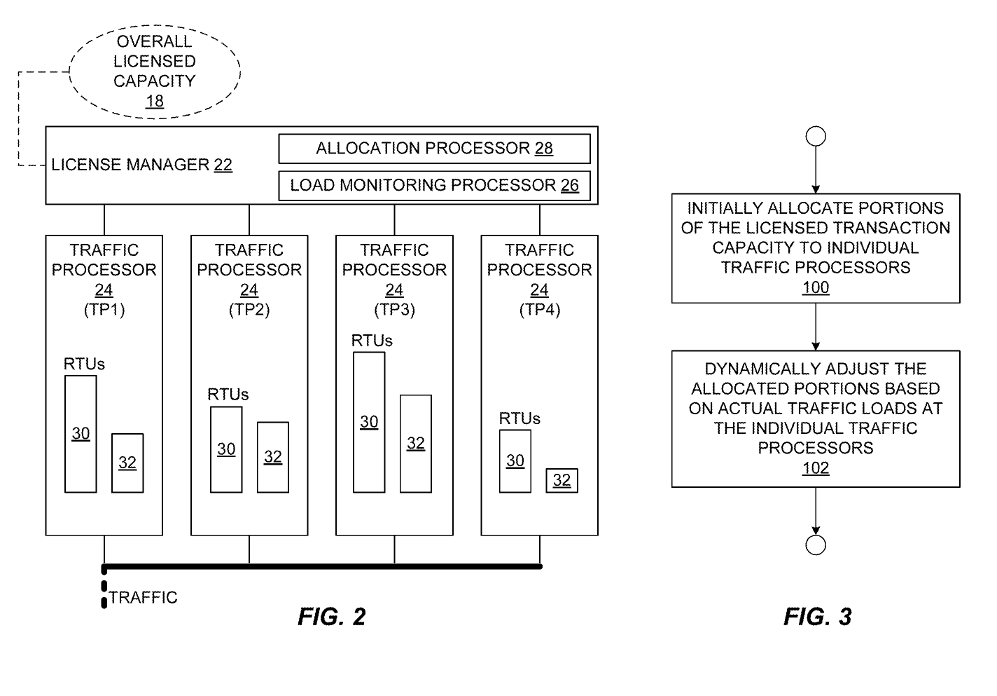

FIG. 2 provides a more detailed view of one embodiment of the license manager 22, wherein the traffic processor set 20 is broken out as a number of individual traffic processors 24. The drawing illustrates TP1 . . . TP4, but those skilled in the art will appreciate that greater or lesser numbers of traffic processors may be involved. Indeed, it should be understood that there may be multiple traffic processor sets 20, each set having a corresponding license manager 22 and a corresponding licensed transaction capacity 18 to draw from for each licensed service being managed. Additionally, or alternatively, there may be one or more license managers 22, each managing multiple traffic processors sets 20. Thus, the teachings herein may be used for managing licensed transaction capacity for different types of services within the same network, and different types of license managers (or differently provisioned license managers) all may be deployed within the telecommunication network 10.

Returning to the diagram, the simplified depiction presented in FIG. 2 provides a ready basis for more detailed discussion of capacity license management for a given service 14 being provided collectively by the individual traffic processors 24. Here, the license manager 22 includes one or more processing circuits that are configured to carry out the capacity license management method illustrated in FIG. 3.

In the processing of FIG. 3, the license manager 22 initially allocates portions of the licensed transaction capacity 18 to individual traffic processors 24, which collectively support the licensed service (Block 100). Processing continues with dynamically adjusting the allocated portions based on actual traffic loads of the individual traffic processors 24 (Block 102).

It should be understood that such processing may be performed as part of a larger set of processing tasks, and that Block 102 generally represents ongoing processing for live operation of the service. Block 102 may be repeated, for example, at time intervals, or performed on an as-needed basis. The need for reallocation of licensed capacity may be detected by continuously or periodically monitoring traffic loads at the individual traffic processors 24. Further, it should be understood that such license management may be performed at the same time for more than one licensed service.

As a non-limiting example of a functional configuration, the processing circuits of the license manager 22 include a traffic load monitoring processor 26 that determines traffic loads of the individual traffic processors 24, such as by measuring traffic loads or by receiving reported traffic loads. The illustrated processing circuits further include an allocation processor 28, which determines the initial allocation and dynamic reallocation of licensed capacity among the traffic processors 24. Thus, the license manager 22 is operative to reserve shares of the licensed capacity for a specific service being provided by or through a number of individual traffic processors 24, based on the traffic loads at those traffic processors.

The license manager's processors may be implemented via the execution of stored program instructions, e.g., a computer program product loaded in or otherwise accessible to the license manager 22. Of course, even with software-based, functional realization of the illustrated processors, at least some of the supporting processing may be performed in hardware, as needed or desired.

Regardless of the implementation details, one sees that each traffic processor 24 has an allocated license capacity 30, labeled as “RTU” in the figure, representing “Rights to Use.” RTU's are measured or otherwise represented as transactions-per-second or other representation of licensed transaction capacity. Thus, performing one licensed transaction consumes (or temporarily claims) a single RTU, such that the number of RTUs at a given traffic processor 24 represents the rate at which transactions for the licensed service can be processed at the given traffic processor.

During live, ongoing operation of the service 14, each traffic processor 24 has a traffic load 32 for a given licensed service. The traffic load 32 generally fluctuates over time, e.g., responsive to changing numbers of subscribers using the service. The traffic load 32 also may change responsive to changes in how the overall amount of service-related traffic is split among the traffic processors 24, such as may be done optionally as part of load redistribution processing.

It generally is not desirable for the level of the traffic load 32 at a given traffic processor 24 to be at or near the level of the allocated license capacity 30. However, those skilled in the art will appreciate that a low level of traffic load 32 relative to the level of allocated license capacity 30 represents underutilization of the overall licensed transaction capacity 18, at least to the extent that one or more of the remaining individual traffic processors 24 have high traffic loads and could process still more traffic if they had higher capacity allocations. The licensing manager 22 and the corresponding method presented herein avoid those underutilization inefficiencies by redistributing allocated capacities as a function of actual license usage at the individual traffic processors 24. In this sense, license usage may be evaluated in relative terms, e.g., high or low, such that allocated capacity may be reduced at a traffic processor 24 having a low traffic load, thereby allowing the allocated capacity to be increased at a traffic processor 24 having a high traffic load.

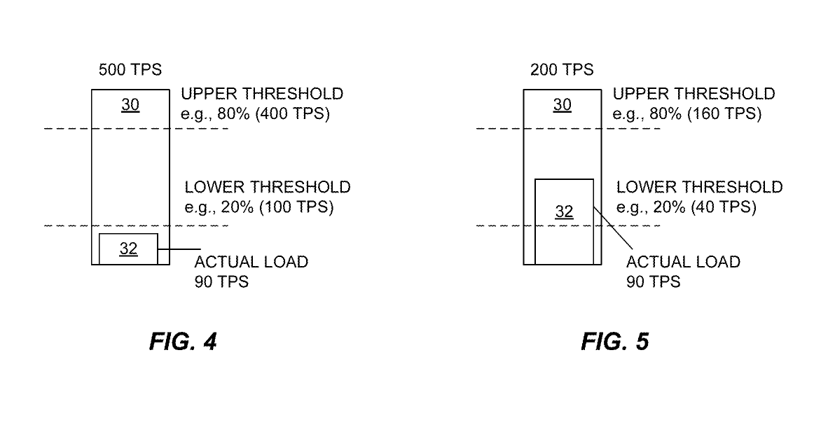

FIGS. 4 and 5 illustrate the effect of dynamic re-allocation by the license manager 22 for a given traffic processor 24, and also illustrate an example basis contemplated herein for evaluating/triggering dynamic reallocation. In particular, FIG. 4 illustrates a hypothetical current capacity allocation 30 of 500 TPS, meaning that the traffic processor currently is permitted to perform up to 500 TPS for the licensed service.

In contrast, the actual traffic load is 90 TPS. The license manager 22 thus may compare the current level of traffic with the allocated capacity to determine whether the traffic processor 24 is lightly loaded or heavily loaded. In the former case, the traffic manager 22 may decrease the allocated capacity, while in the latter case the traffic manager may increase the allocated capacity, assuming reserve capacity is available.

As shown, the low/high evaluations may be made using lower and upper load thresholds. These load thresholds can be expressed as percentages of the currently allocated capacity, such that the high and low thresholds remain consistent in relation to changes in the allocated capacity. In FIG. 4, for example, the lower threshold is set at twenty percent of the currently allocated 500 TPS capacity. Numerically, this setting equates to 100 MPS for the current allocation. Similarly, the upper threshold is set at eighty percent of the allocated capacity, which equates to 400 MPS for the current capacity allocation.

In response to determining that license usage is low, the license manager 22 decreases the allocated capacity to 200 MPS, which is illustrated in FIG. 5. (In one or more embodiments, the amount by which the allocated capacity is decreased represents the amount by which licensed capacity can be increased at other traffic processors 24.) With the changed allocation, one sees that the actual traffic load is much better centered between the lower and upper thresholds, which now equate to 40 MPS and 160 MPS, respectively.

It is contemplated herein that the allocation adjustments are made in consideration of the difference between the actual traffic load and the currently allocated capacity, and/or the difference between the actual traffic load and the low/high thresholds. From another perspective, the license manager 22 may determine the allocation adjustment so that new capacity allocation substantially centers the actual traffic load between the levels determined by the low and high thresholds. Note that the actual traffic load may be determined at timed intervals, such as where the individual traffic processors 24 periodically report traffic load information to the license manager 22, or where the license manager 22 periodically queries for such information. In any case, the traffic load information may represent filtered or otherwise time-qualified values, to provide more reliable values for comparison.

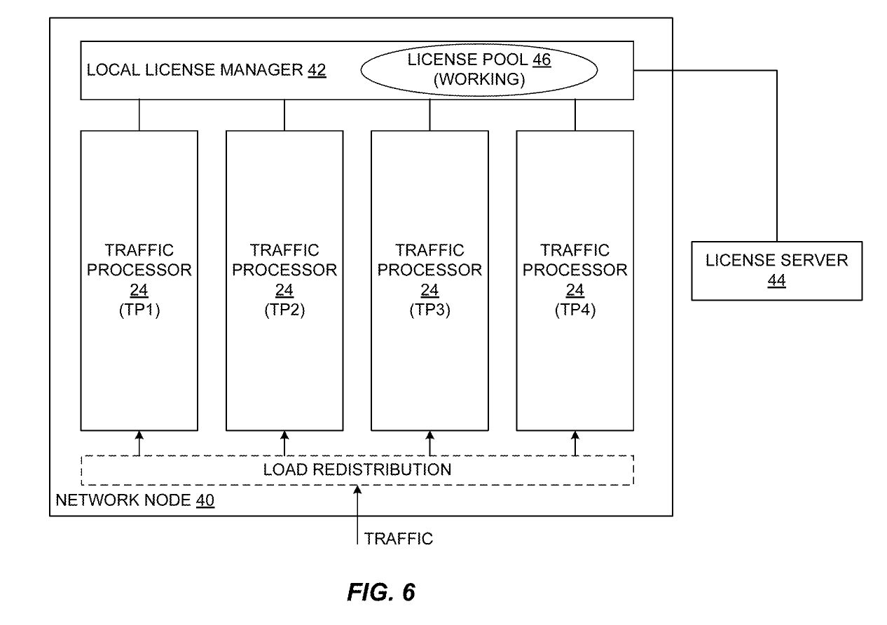

FIG. 6 illustrates a basis for practicing the above dynamic capacity reallocation, wherein a single node 40 includes a number of individual traffic processors 24, denoted as TP1 through TP4. While the telecommunication network 10 is not illustrated in FIG. 6, in one or more embodiments the node 40 comprises part of the telecommunication network 10. Further, the previously described license manager 22 may be implemented in whole or in part in a local license manager 42, which is implemented in or associated with the node 40. Alternatively, the previously described license manager 22 may be implemented in whole or in part in a license server 44, which may, for example, manage the overall licensed transaction capacity for the node 40.

Thus, in at least one embodiment, the local license manager 42 “receives” the overall licensed transaction capacity 18, which is collectively allocated to the node 40, and makes an initial allocation of portions of that capacity to the individual traffic processors TP1-TP4. After that, the local license manager 42 dynamically reallocates the allocated portions as a function of actual traffic loads at TP1-TP4. The local license manager 42 also may request increases in the overall licensed capacity 18 from the license server 18, such as when all or most of the original licensed transaction capacity 18 is being used by the traffic processors TP1-TP4.

The license manager 22, such as represented by the local license manager 42 in the illustrated embodiment, may hold a pool 46 of license tokens. The licensed transaction capacity 18 thus may be represented in the pool 46 as an overall number of license tokens. Initially, the local license manager 42 may empty the pool 46 by making initial allocations of license tokens to the individual traffic processors 24.

During operation—i.e., processing of traffic for the licensed service(s)—the local license manager 42 uses the pool 46 as a temporary holder for license tokens taken back from one or more of the traffic processors 24 that are lightly loaded, for reallocation as needed to one or more of the traffic processors 24 that are heavily loaded. More particularly, the license manager 22 as taught herein may be configured to release a number of license tokens from a traffic processor 24 having a low license token usage relative its current allocated share of license tokens, and store the released license tokens at least temporarily in the license token pool 46. Further, the license manager 22 uses the pool 46 as a reservoir of available license tokens, of course it may not hold license tokens in the pool 46, other than on a transient basis as it performs dynamic reallocations. In any case, in at least one embodiment, the pool 46 holds license tokens released (or additionally allocated), and the license manager 22 allocates a number of license tokens from the pool 46 to a traffic processor 24 having a high license token usage relative to its current allocated share of license tokens.

In another embodiment, the local license manager 42 reports traffic load information for the traffic processors TP1-TP4, e.g., it may report license usage levels, to the license server 44. With that information, the license server 44 performs the dynamic reallocation of the licensed transaction capacity 18 among the traffic processors TP1-TP4, within the node 40. One advantage of this approach is that the reallocation intelligence is consolidated in the license server 44 and thus exploited for other nodes of traffic processors, having their own overall license capacity allocations, or sharing their license capacity allocations with the illustrated node 40. Put another, way, the dynamic adjustment of allocated capacity may be performed by local license managers within given nodes containing the traffic processors 24 of interest, or may be performed by the license server 44, independently for sets of traffic processors in single nodes, or for sets of traffic processors spanning nodes.

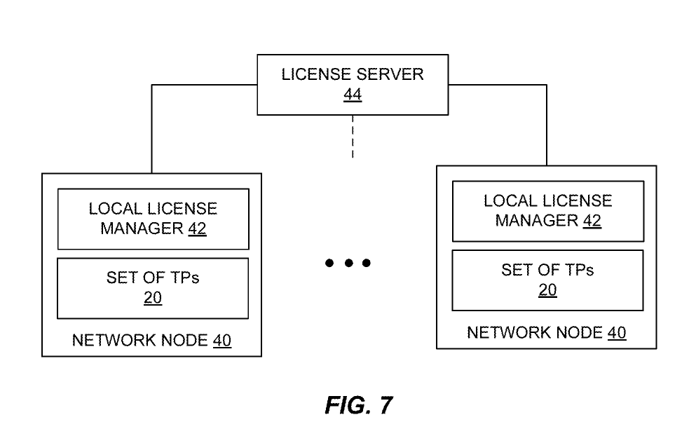

FIG. 7, for example, illustrates a license server 44 associated with multiple local license servers 42 in multiple nodes 40 within the telecommunication network. The different nodes 40 may provide the same licensed service, or may provide different licensed services, and may share overall licensed transaction capacity, or each have their own overall licensed transaction capacities. For example, a set of traffic processors of interest may span two or more nodes 40, and the license server can be configured to perform the dynamic adjustment of allocated portions of licensed capacity across the nodes 40.

Whether done locally within individual nodes 40, or done across nodes 40, the overall licensed transaction capacity 18 may be viewed as a pool of license tokens, each token representing a fraction of the overall licensed capacity. Thus, the licensing manager 22 may comprise one or more processing circuits configured to distribute an overall number of license tokens among individual traffic processors 24 in a traffic processor set 20. The overall number of license tokens represents the licensed transaction capacity 18 allocated to the traffic processor set 20.

The licensing manager 22 in such embodiments is further configured to redistribute the license tokens among the individual traffic processors 24, responsive to differences in license token usage levels among the individual traffic processors. In operation, the license manager 22 periodically determines the differences in license token usage levels among the individual traffic processors 24, and correspondingly redistributes the license tokens among the individual traffic processors 24 on an as-needed basis. As described earlier, license token usage levels for the individual traffic processors 24 may be determined by comparing current license token usage levels to defined upper and lower usage thresholds. For example, the license manager 22 may release license tokens from a traffic processor having a low level of license token usage, and give some or all of the released tokens to another traffic processor 24 having a high level of license token usage.

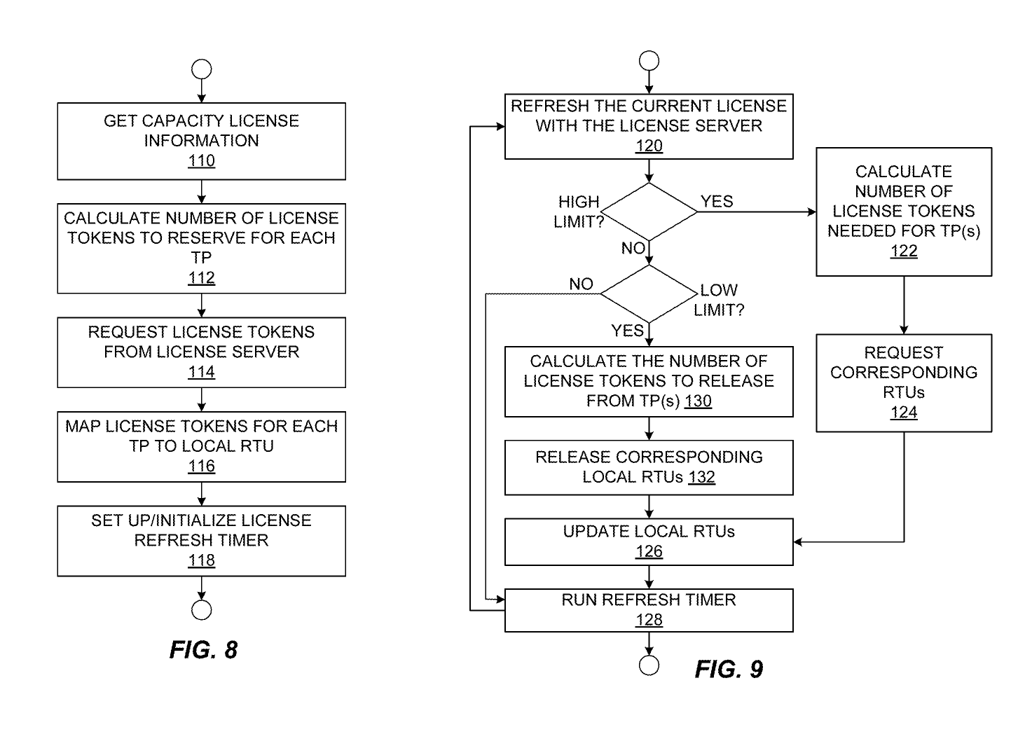

FIG. 8 illustrates example processing, wherein the license manager obtains capacity license information (Block 110), e.g., the license manager 22 determines the overall licensed transaction capacity 18. Processing continues with the license manager 22 determining the number of license tokens to reserve for each traffic processor 24 (Block 112), where the illustration abbreviates “traffic processor” as “TP.” As a non-limiting example, the license manager 22 may be configured to make an initial uniform distribution of license tokens, such as by dividing the overall number of license tokens by the number of individual traffic processors 24 sharing that overall number of license tokens.

Regardless of whether the initial allocation of licensed capacity is uniform or weighted, such as based on knowledge of expected traffic loads, the illustrated processing continues with the license manager 22 requesting or otherwise obtaining the required numbers of license tokens (Block 114), and mapping the allocated license tokens at each traffic processor 24 to local RTUs (Block 116). For example, with momentary reference back to FIG. 6, the local license manager 42 may operate as the license manager 22, and thus may request the required numbers of license tokens from the license server 44, and then map the allocated license tokens to corresponding RTUs within each traffic processor 24 in the local license manager's node 40.

In any case, processing continues with setting up/initializing a license refresh timer (Block 118), which is used to time the interval for evaluating whether dynamic adjustment of the allocated license tokens is needed, based on current traffic loads at the individual traffic processors 24. The license refresh timer may be, for example, a software-based timer, or may be a hardware timer, as needed or desired. The expiration period of the license refresh timer may be preconfigured and/or may be dynamically configured, or at least dynamically updated. For example, the expiration period may be shortened or lengthened responsive to observed changes in traffic loads or distributions of traffic loads from interval to interval.

Where FIG. 8 illustrates one embodiment of initial license token allocations, FIG. 9 illustrates one embodiment of the processing that may be carried out at timed expirations of the license refresh timer. Assuming a local license manager 42 and a license server 44 as shown in FIG. 6, the processing of FIG. 9 thus begins with the local license manger 42 refreshing the node's current capacity license with the license server 44 (Block 120). This processing operation may include requesting an overall increase in the licensed transaction capacity 18, such as would be appropriate if heavy traffic loads existed at some or all of the individual traffic processors 24 within the node 40 shown in FIG. 6.

The illustrated blocks 122, 124, 126, 128, 130, and 132 are then carried out for each traffic processor of interest, and it should be understood that at least these blocks in the illustrated processing flow may be replicated for parallel evaluation of more than one traffic processor 24 at a time. Thus, assuming a given traffic processor 24, it is determined whether the current level of license usage is high or low. If the level is high, processing continues with a determination of the number of additional license tokens needed to achieve the desired margin between the actual traffic load and the traffic processor's licensed capacity limit, as defined by the number of license tokens allocated to it (Block 122). The needed number of additional tokens are requested (Block 124), and processing continues with updating the local RTUs at the traffic processor 24 (Block 126).

Processing further continues with resetting of the license refresh timer, at least for this given traffic processor 24 (Block 128). For example, the interval at which each traffic processor's load is evaluated may be timed independently, synchronous or asynchronous with the timing of intervals for the other traffic processors 24. Tokens released from one traffic processor 24 may be banked or otherwise held in a reserve pool until the next traffic processor's token allocation is evaluated. Alternatively, Blocks 122, 124, and 126 may be understood as being done in parallel for each traffic processor 24, while timing blocks 120 and 128 may be understood as common interval timing applied to all traffic processors 24 in a set 20 of traffic processors.

The remaining processing, Blocks 130 and 132 are reached in the case that the current traffic load is low, rather than high. In this case, processing includes calculating the number of license tokens to release (Block 130), followed by releasing the determined number of tokens, e.g., for reassignment to more heavily loaded traffic processors 24 (Block 132). Again, the calculation of how many tokens to release may be based on the strategy of maintaining the current actual traffic load midways between the upper and lower load thresholds, which may be expressed in terms of percentage utilization of the allocated number of tokens.

In the above processing, the requested tokens may be granted using license tokens released from traffic processors 24 having low traffic loads, or may be granted based on an increase in the overall licensed transaction capacity 18, such as permitted by a license server 44. Further, increasing the allocation of license tokens at a given traffic processor 24 may use a mix of released license tokens and newly granted license tokens.

In at least one embodiment, however, it should be understood that the overall licensed transaction capacity 18 is at least temporarily fixed, and the allocations of license tokens at one or more heavily loaded traffic processors 24 are increased using license tokens released from one or more lightly loaded traffic processors 24. Thus, with a fixed overall license capacity, license capacity management as taught herein uses a dynamic redistribution of the overall license capacity to reflect differences in traffic loads at the individual traffic processors 24 sharing that overall license capacity.

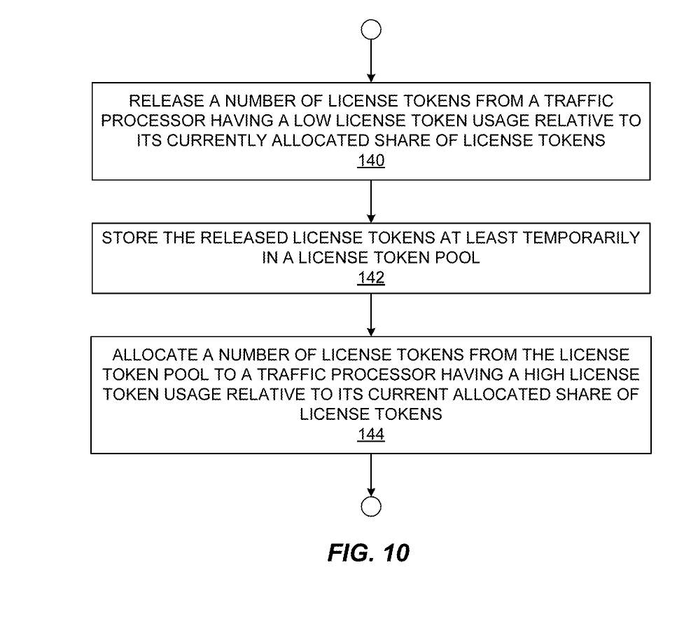

FIG. 10 illustrates one embodiment of a method of managing license capacity for a service in a telecommunication network, which is based on adjusting license token allocations across individual traffic processors 24, as a function of license token usage at those processors. Assuming some current allocation of license tokens at each of the traffic processors of interest, the illustrated processing begins with releasing a number of license tokens from a traffic processor having a low license token usage relative its current allocated share of license tokens (Block 140). Momentarily referring back to FIG. 4, one sees that the determination of low license token usage may be made for a given traffic processor 24 by comparing the actual traffic load 32 for the licensed service that is of interest to a lower load threshold. The lower load threshold may be defined as a percentage of the share of licensed capacity that is currently allocated to the given traffic processor 24.

Turning back to FIG. 10, the illustrated processing continues with storing the released license tokens at least temporarily in a license token pool. As a non-limiting reference, one may refer to FIG. 6, which illustrates a license pool 46 residing within the local license manager 42. Of course, the license pool 46 may exist elsewhere, and may be implemented, for example, as a logical construct. As a specific but non-limiting example, the license pool 46 may simply comprise one or more software and/or hardware counters (or count values) that are used to track the number of currently unallocated or otherwise available license tokens. Thus, if a given traffic processor 24 is using a low percentage of its current license token allocation, that allocation may be reduced by some number and the count of available tokens in the license pool 46 is correspondingly increased by that number.

Returning back to FIG. 10, one sees that the illustrated processing continues with allocating a number of license tokens from the license token pool to a traffic processor having a high license token usage relative to its current allocated share of license tokens (Block 144). Correspondingly, in the embodiment described immediately above, the count of available license tokens would be decreased by the number assigned to the heavily loaded traffic processor. Those skilled in the art will recognize that these monitoring and adjusting steps can be ongoing, such as at periodic measurement/adjustment intervals, and can involve any number of traffic processors 24, within one node or across nodes. Moreover, the capacity license for multiple licensed services may be individually managed in accordance with these teachings.

Generally, then, FIGS. 8, 9, 10 and the other illustrative figures and examples given herein are to be understood as non-limiting. Broadly, the teachings herein provide an apparatus and method for managing license capacity for a service in a telecommunication network based on initially allocating portions of a licensed transaction capacity to individual traffic processors supporting the service, and dynamically adjusting the allocated portions based on actual traffic loads of the individual traffic processors. The allocation may be represented in terms of license tokens or other functional representations of an overall licensed transaction capacity 18, and the traffic loads may be determined by tracking license utilization, e.g., by tracking the transactions-per-second being conducted individually by the involved traffic processors 24.

Regardless, according to the teachings herein, the allocated portions are dynamically adjusted to reflect the distribution of actual traffic loads among the individual traffic processors 24, such that licensed capacity is decreased at lightly loaded ones of the traffic processors 24, and correspondingly increased at heavily loaded ones the traffic processors 24. For example, the overall licensed transaction capacity 18 may define an overall messages-per-second (MPS) transaction limit, such as for an IM service. There, initially allocating portions of the overall licensed transaction capacity 18 to individual traffic processors 24 comprises allocating per-processor MPS transaction limits as fractional shares of the overall MPS transaction limit. These fractional shares are then increased or decreased to reflect actual traffic loads.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method of managing license capacity for a service in a telecommunication network comprising:
initially allocating portions of a licensed transaction capacity to individual traffic processors supporting the service; and
dynamically adjusting the allocated portions based on actual traffic loads of the individual traffic processors.

2. The method of claim 1, wherein dynamically adjusting the allocated portions based on actual traffic loads of the individual traffic processors comprises decreasing the allocated portion at one or more traffic processors determined to have low traffic loads and increasing the allocated portion at one or more other traffic processors determined to have high traffic loads.

3. The method of claim 2, further comprising determining whether a first given traffic processor has a low traffic load by comparing the actual traffic load of the first given traffic processor to a lower load threshold, and determining whether a second given traffic processor has a high traffic load by comparing the actual traffic load of the second given traffic processor to an upper load threshold.

4. The method of claim 3, further comprising defining the lower and upper load thresholds according to allocated portion percentage values, such that values of the lower load threshold and the upper load threshold are relative to the currently allocated portions of licensed transaction capacity respectively at the first and second given traffic processors.

5. The method of claim 2, further comprising determining an amount by which to decrease the allocated portion at a given traffic processor having a low traffic load as a function of the difference between the actual traffic load and the lower load threshold, and determining an amount by which to increase the allocated portion at a given traffic processor having a high traffic load as a function of the difference between the actual traffic load and the upper load threshold, and as limited by available portions of the licensed transaction capacity.

6. The method of claim 1, wherein dynamically adjusting the allocated portions based on actual traffic loads of the individual traffic processors comprises dynamically adjusting the allocated portions across a set of traffic processors in a single node of the telecommunication network, and wherein the licensed transaction capacity is collectively allocated to the set of traffic processors within that single node.

7. The method of claim 1, wherein dynamically adjusting the allocated portions based on actual traffic loads of the individual traffic processors comprises dynamically adjusting the allocated portions across a set of traffic processors that span two or more nodes of the telecommunication network, and wherein the licensed transaction capacity is collectively allocated to the set of traffic processors within those two or more nodes.

8. The method of claim 1, wherein each of the two or more nodes includes a local license manager configured to report actual traffic load information for the traffic processors managed by the local license manager, and further comprising an inter-node license manager configured to direct the dynamic adjustment of allocated portions across the two or more nodes.

9. The method of claim 1, wherein initially allocating portions of the licensed transaction capacity to individual traffic processors supporting the service comprises initially reserving a number of license tokens for each traffic processor from an overall number of license tokens corresponding to the licensed transaction capacity.

10. The method of claim 9, wherein dynamically adjusting the allocated portions based on evaluating traffic loading for the individual traffic processors comprises periodically evaluating a current level of license token usage at each traffic processor, and selectively reallocating license tokens from traffic processors with low levels of license token usage to traffic processors having high levels of license usage, wherein low and high levels of license usage are evaluated with respect to defined low and high usage thresholds.

11. The method of claim 10, further comprising selectively requesting additional license tokens from an associated license server in response to determining that one or more of the traffic processors have a high level of license usage, and, if any additional license tokens are provided, correspondingly allocating at least a portion of the additional license tokens to the one or more traffic processors having a high level of license usage.

12. The method of claim 1, wherein initially allocating portions of the licensed transaction capacity to individual traffic processors supporting the service comprises initially distributing an overall number of license tokens corresponding to the licensed transaction capacity among the traffic processors, and wherein periodically evaluating a current level of license token usage at each traffic processor comprises periodically evaluating current license usage levels at the individual traffic processors, and selectively reallocating license tokens among the traffic processors to reflect differences in the license usage levels.

13. The method of claim 1, wherein the overall licensed transaction capacity defines an overall messages-per-second (MPS) transaction limit, and wherein initially allocating portions of an overall licensed transaction capacity to individual traffic processors in the telecommunication network comprises allocating per-processor MPS transaction limits as fractional shares of the overall MPS transaction limit.

14. A license manager for managing license capacity for a service in a telecommunication network, said license manager comprising one or more processing circuits configured to:
initially allocate portions of a licensed transaction capacity to individual traffic processors supporting the service; and
dynamically adjust the allocated portions based on actual traffic loads of the individual traffic processors.

15. The license manager of claim 14, wherein the license manager is configured to dynamically adjust the allocated portions by decreasing the allocated portion at one or more traffic processors determined to have low traffic loads and increasing the allocated portion at one or more traffic processors determined to have high traffic loads.

16. The license manager of claim 15, wherein the license manager is configured to determine whether a given traffic processor has a low traffic load by comparing the actual traffic load of the given traffic processor to a lower load threshold, and determine whether a given traffic processor has a high traffic load by comparing the actual traffic load of the given traffic processor to an upper load threshold.

17. The license manager of claim 16, wherein the license manager is configured to define the lower and upper load thresholds for each traffic processor based on allocated portion percentage values, such that low and high traffic load comparisons for any given traffic processor are relative to the currently allocated portion at the given traffic processor.

18. The license manager of claim 15, wherein the license manager is configured to determine an amount by which to decrease the allocated portion at a given traffic processor having a low traffic load as a function of the difference between the actual traffic load and the lower load threshold, and determining an amount by which to increase the allocated portion at a given traffic processor having a high traffic load as a function of the difference between the actual traffic load and the upper load threshold, and as limited by available portions of the licensed transaction capacity.

19. The license manager of claim 14, wherein the individual traffic processors comprise a set of traffic processors within a single node of the telecommunication network, and wherein the license manager comprises a local license manager operating within the single node, and wherein the local license manager is configured to dynamically adjust the allocated portions across the set of traffic processors.

20. The license manager of claim 14, wherein the individual traffic processors comprise a set of traffic processors spanning two or more nodes within the telecommunication network, and wherein the license manager comprises a license server configured to dynamically adjust the allocated portions across the two or more nodes.

21. The license manager of claim 20, wherein the license manager further comprises a local license manager in each of the two or more nodes, each local license manager communicatively coupled to the license server and configured to report actual traffic load information to the license server, to support the dynamic adjustment of the allocated portions across the two or more nodes by the license server.

22. The license manager of claim 21, wherein each local license manager is configured to request additional portions of the licensed transaction capacity from the license server in response to detecting high traffic load conditions at the local license manager's node, and configured to release previously allocated portions of the licensed transaction capacity to the license server in response to detecting low traffic load conditions at the local license manager's node.

23. The license manager of claim 14, wherein the license manager is configured to initially allocate portions of the licensed transaction capacity to the individual traffic processors by initially reserving a number of license tokens for each traffic processor from an overall number of license tokens corresponding to the licensed transaction capacity.

24. The license manager of claim 23, wherein the license manager is configured to dynamically adjust the allocated portions by periodically evaluating a current level of license token usage at each traffic processor and selectively reallocating license tokens from traffic processors with low levels of license token usage to traffic processors having high levels of license usage, wherein low and high levels are evaluated with respect to defined low and high usage thresholds.

25. The license manager of claim 24, wherein the license manager is configured to selectively request additional license tokens from an associated license server in response to determining that one or more of the traffic processors have a high level of license usage, and, if any additional license tokens are provided, correspondingly allocate at least a portion of the additional license tokens to the one or more traffic processors having a high level of license usage.

26. The license manager of claim 14, wherein the license manager is configured to initially allocate portions of the licensed transaction capacity to the individual traffic processors by initially distributing an overall number of license tokens corresponding to the licensed transaction capacity among the traffic processors, and is configured to periodically evaluate the current level of license token usage at each traffic processor by periodically evaluating current license usage levels at the individual traffic processors and selectively reallocate license tokens among the traffic processors to reflect differences in the license usage levels.

27. The license manager of claim 14, wherein the overall licensed transaction capacity defines an overall messages-per-second (MPS) transaction limit, and wherein the license manager is configured to initially allocate portions of the overall licensed transaction capacity to the individual traffic processors by allocating per-processor MPS transaction limits as fractional shares of the overall MPS transaction limit.

28. The license manager of claim 14, wherein the one or more processing circuits comprise a traffic load monitoring processor configured to process load information relating to the actual traffic loads at the individual traffic processors, and an allocation processor configured to perform said dynamic adjustment of the allocated portions based on the load information.

29. A license manager for managing a transaction capacity license for a service in a telecommunication network, said license manager comprising one or more processing circuits configured to:
distribute an overall number of license tokens among individual traffic processors in a set of traffic processors, said overall number of license tokens representing a licensed transaction capacity for the service; and
redistribute the license tokens among the individual traffic processors responsive to differences in license token usage levels among the individual traffic processors.

30. The license manager of claim 29, wherein the license manager periodically determines the differences in license token usage levels among the individual traffic processors, and correspondingly redistributes the license tokens among the individual traffic processors on an as-needed basis.

31. The license manager of claim 29, wherein the license manager redistributes the license tokens among the individual traffic processors responsive to differences in license token usage levels among the individual traffic processors based on periodically evaluating a license token usage level for each traffic processor relative to a low usage threshold and a high usage threshold, and selectively releasing license tokens from a given one of the traffic processors having a low license token usage level and giving some or all of the released license tokens to a given one of the traffic processors having a high license token usage level.

32. A method of managing license capacity for a service in a telecommunication network comprising:
releasing a number of license tokens from a traffic processor having a low license token usage relative its current allocated share of license tokens;
storing the released license tokens at least temporarily in a license token pool; and
allocating a number of license tokens from the license token pool to a traffic processor having a high license token usage relative to its current allocated share of license tokens.
